(19) United States
(12) Patent Application Publication
(10) Pub. No.: US 2022/0341200 A1
(43) Pub. Date: Oct. 27, 2022

(54) SYSTEMS, METHODS AND APPARATUS FOR IMPROVED CONTAINMENT UNIT

(71) Applicant: CONCEPTS TO SOLUTIONS INC., Oro-Medonte (CA)

(72) Inventors: Vernon SOLOMON, Oro-Medonte (CA); Aaron STYLES, Hillsdale (CA)

(73) Assignee: CONCEPTS TO SOLUTIONS INC., Oro-Medonte, ON (CA)

(21) Appl. No.: 17/765,600

(22) PCT Filed: Oct. 1, 2020
(86) PCT No.: PCT/CA2020/000113

§ 371 Date: Mar. 31, 2022

Related U.S. Application Data
(60) Provisional application No. 62/908,864, filed on Oct. 1, 2019.

(51) Int. Cl. E04H 1/12; E04H 15/20; E04H 3/08; A61G 10/00

(52) U.S. Cl. CPC E04H 1/1277; E04H 15/20; E04H 3/08; A61G 10/005

(57) ABSTRACT

The present invention relates to a portable, self-contained, mobile cleanroom for containment, the cleanroom comprising an inflated sealed structure forming a sealed interior space having a sealable entrance and exit, and may provide a positive or negative-pressure in the interior space. The structure may be supported by air-filled frame members, or by a rigid frame. The cleanroom may find use in manufacturing, including manufacture of high potency chemicals including high-potency active pharmaceutical ingredients (HP API's); disease preparedness; and storage.

### CROSS-REFERENCE TO RELATED APPLICATION

The present application claims priority to the PCT application PCT/CA2020/000113 filed Oct. 1, 2020, which claims priority over U.S. provisional patent application Ser. No. 62/908,864, filed on Oct. 1, 2019, both of which are incorporated by reference herein.

### TECHNICAL FIELD

The present invention relates to systems, methods and apparatus for an improved containment unit optimized for use in manufacturing, disease preparedness, storage and other applications. The present invention is directed to a self-contained, portable and mobile containment or cleanroom assembly or unit which provides a simple to use yet effective systems, methods and apparatus for use in the manufacture of high potency chemicals, disease preparedness, and cleanroom manufacturing operations, providing a positive or negative pressure environment.

### BACKGROUND AND SUMMARY

The typical manufacturing environments for pharmaceutical, biological, chemical ingredients, as well as other contamination sensitive components utilize standardized cleanroom techniques. uncontaminated environment may be maintained, also know as “Cleanrooms”. A “cleanroom” is a specially designed & constructed room in which the air supply, air distribution, filtration of air supply, materials of construction, and operating procedures are regulated to control airborne particle concentrations to meet appropriate cleanliness levels. Cleanrooms have controlled environments in which variables such as the density of airborne particles per cubic meter or the temperature of the room are controlled. For example, Cleanrooms are often used in facilities for the manufacture and assembly of electronic components, or in the biological and pharmaceutical sciences. Cleanrooms are essential for these manufacturing processes, which require high degrees of cleanliness and/or precise temperature and humidity control. The need for Cleanrooms that can control the level of contamination (e.g. particulate and/or biological, etc.) in the sub micron particle range is increasing. Cleanrooms can also be designed for containment of hazardous chemical or biological elements.

Typical systems have been created to meet repeated use, typically for a single purpose, as required in the electronics, photonics, aerospace, trace metals, pharmaceutical, and biological/biotechnology industries. Depending upon the needs of the cleanroom, these rooms primarily rely on filtering techniques, positive or negative pressure, as well as other devices, to maintain contaminant free environments, and a rigorous cleaning regime to ensure no cross contamination between batches of product. In addition to keeping contaminants out, it may be necessary to keep material within the cleanroom from being released into the external environment (e.g. outside the cleanroom).

One such example is in the manufacture of high-potency active pharmaceutical ingredients. A significant proportion of new drugs under development contain high-potency active pharmaceutical ingredients (HPAPIs), which is leading to explosive growth in demand for their production. The toxicity of HPAPIs, however, presents handling challenges and typically requires heavy investment in specialized containment to ensure that employees and their environment are protected from exposure.

While pharmaceutical and biopharmaceutical producers are focused on quality, safety and drug efficacy, they are continuously challenged to reduce cost and improve manufacturing efficiencies. To do this the industry must constantly innovate, retaining a competitive edge, while also satisfying clients and meeting regulatory demands. In situations where cleanrooms or other containment units must be deployed rapidly or where a traditional cleanroom is not economically feasible, prior art systems, apparatus and methods do not take into these situational and/or environmental factors so as not to be useful. Initial cost of purpose-built facilities, for example, is a limiting factor to drug development and trials, if this cost can be reduced while limiting risk as an outcome of this technology, the world will benefit.

There remains a need for cleanrooms or other containment units that can adjust and/or adapt based on economic, situational or environmental factors. Accordingly, it is an object of this invention to at least partially overcome some of the disadvantages of the prior art.

### BRIEF DESCRIPTION OF THE DRAWINGS

In the drawings, which illustrate embodiments of the invention:

FIG. 1 provides a top view showing the primary and secondary structures as preferred embodiments of the present invention.

FIG. 2 provides a side view showing the primary and secondary structures as preferred embodiments of the present invention.

FIG. 3 provides a front view showing the primary and secondary structures as preferred embodiments of the present invention.

FIG. 4 provides a perspective view showing the primary and secondary structures as preferred embodiments of the present invention.

FIG. 5 provides a top view of the secondary structure in accordance with a preferred embodiment of the present invention.

FIG. 6 provides a side view of the secondary structure in accordance with a preferred embodiment of the present invention.

FIG. 7 provides a perspective view of the secondary structure in accordance with a preferred embodiment of the present invention.

FIG. 8 provides a top view showing the primary structure in accordance with an embodiment of the present invention.

FIG. 9 provides a side view showing the primary structure in accordance with an embodiment of the present invention.

FIG. 10 provides a front view showing the primary structure in accordance with an embodiment of the present invention.

FIG. 11 provides a perspective view showing the primary structure in accordance with an embodiment of the present invention.

FIGS. 12 and 13 provides a cross-sectional view showing the primary structure in accordance with an embodiment of the present invention.

FIGS. 14 to 16 provide views showing a representative liner used in association with the primary structure in accordance with an embodiment of the present invention.

### DESCRIPTION OF THE PREFERRED EMBODIMENTS

The description that follows, and the embodiments described therein, is provided by way of illustration of an example, or examples, of particular embodiments of the principles and aspects of the present invention. These examples are provided for the purposes of explanation, and not of limitation, of those principles and of the invention.

It should also be appreciated that the present invention can be implemented in numerous ways, including as a process, method, an apparatus, a system, a device or a method. In this specification, these implementations, or any other form that the invention may take, may be referred to as processes. In general, the order of the steps of the disclosed processes may be altered within the scope of the invention. The description that follows, and the embodiments described therein, is provided by way of illustration of an example, or examples, of particular embodiments of the principles and aspects of the present invention. These examples are provided for the purposes of explanation, and not of limitation, of those principles and of the invention.

It will be understood by a person skilled in the relevant art that in different geographical regions and jurisdictions these terms and definitions used herein may be given different names, but relate to the same respective systems.

Preferred embodiments of the present invention can be implemented in numerous configurations depending on implementation choices based upon the principles described herein. Various specific aspects are disclosed, which are illustrative embodiments not to be construed as limiting the scope of the disclosure. Although the present specification describes components and functions implemented in the embodiments with reference to standards and protocols known to a person skilled in the art, the present disclosures as well as the embodiments of the present invention are not limited to any specific standard or protocol.

The present invention is directed to systems, methods and apparatus that may be rapidly deployable, self-contained and economical that can provided the needed level of protection for workers, facilities and environments in various setting, including in industrial settings (e.g. used in more efficient drug trials (e.g. failing or succeeding faster)) as well as in healthcare settings such as, for example, pandemic or other outbreak settings.

To prevent cross contamination between product batches, systems, methods, process and hardware are increasingly changing to single use equipment and processes, however the tertiary containment of the environment is still through multi use facilities. An aspect of the present invention is directed to bringing single use containment to the delivery of HPAPI production, as well as allowing for a rapidly deployed methodology for biological containment as may be required, such as, for example, in a pandemic.

A preferred embodiment is directed to a cleanroom that may be used as a single use containment system for the manufacturer of HPAPIs. The manufacture of HPAPIs requires containment of the ingredients and the final product as well as specialized disposal of the equipment used in their manufacture. However, because only small quantities of the HPAPIs are typically required, and these small quantities may last for a significant period of time, it may not be economically feasible to have traditional cleanrooms used in their manufacture. The total cost of use and disposal of the facilities involved in the manufacture of the HPAPIs renders the use of traditional cleanrooms unattractive to manufacturers. The process, methods and apparatus used in and the design of the present invention attempts to address these concerns as an aspect of the present invention are systems, methods, and apparatus that can be easily adapted for a signal use that can be easily discarded.

In yet another preferred embodiment, the present invention can be used where quarantine or other control (e.g. biologic, chemical, etc.) is needed. The embodiments of the present invention can be delivered quickly to areas where, for example, there is a disease outbreak. IN a preferred embodiment, these embodiments of the invention can be rapidly assembled and deployed to act as quarantine units for infected or suspected individuals. The entrance and exit of these preferred embodiments can then be equipped with the necessary decontamination equipment. The design of the present invention is of sufficient low cost and ease of assembly that it can be deployed quickly and in sufficient numbers to address the needs of any location in which pandemic preparedness is desired or required. The embodiments of the present invention are also made of material that it could withstand repeated cleaning and/or decontamination know in the art so as to be used repeatedly.

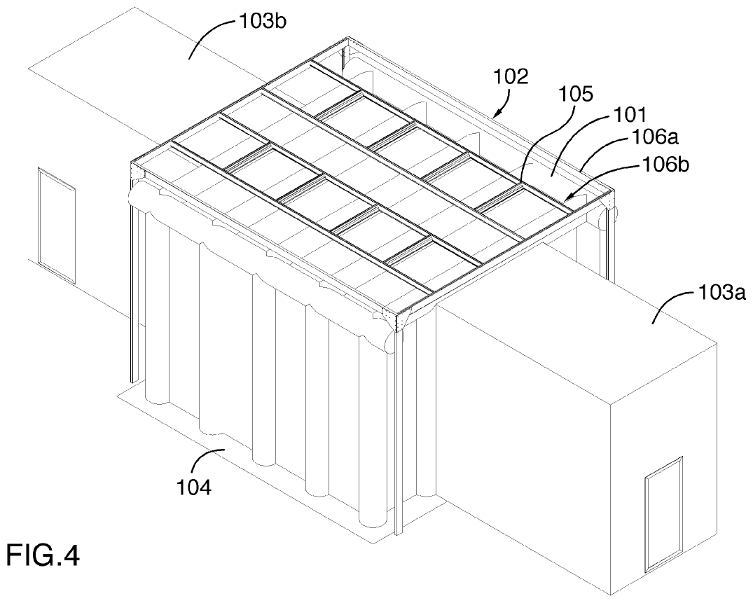

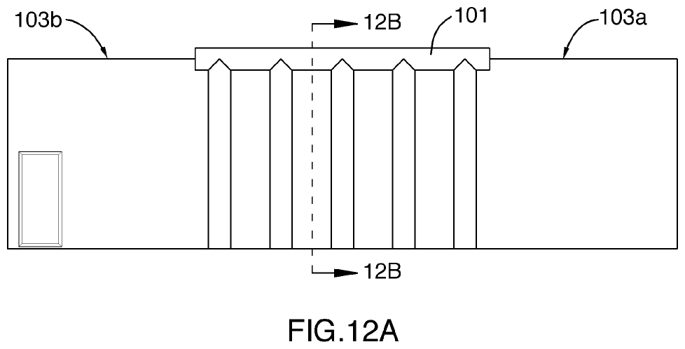

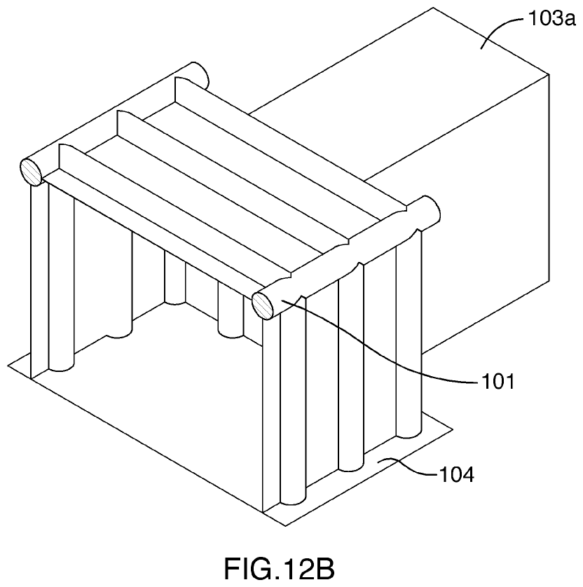

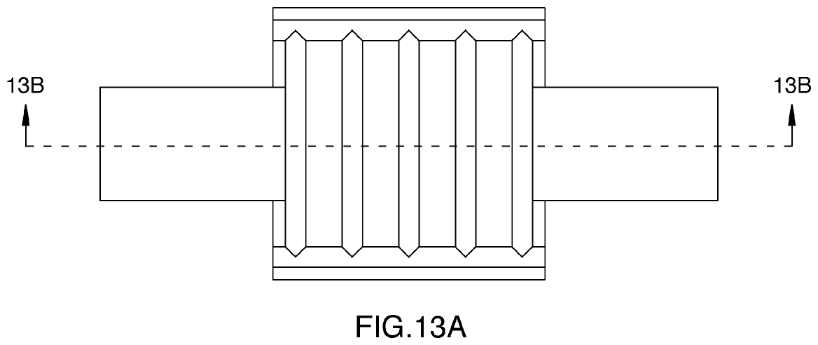

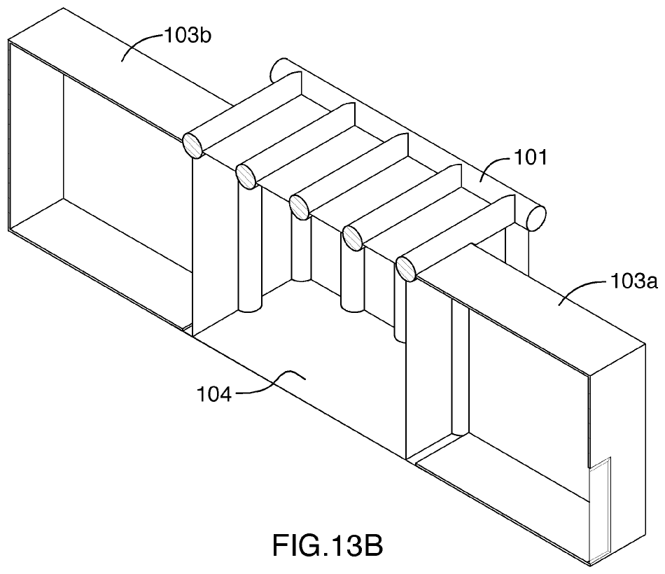

The present invention is directed to a portable, self-contained, easy to assemble and economical cleanroom with positive or negative air-pressure within the cleanroom for biological, chemical or other containment that can be used in a number of situations and environments. Another aspect of the invention is directed to the use of negative air-pressure within the cleanroom's structure (e.g. interior space or room) in order to keep contaminants from the interior of the cleanroom escaping into the surrounding environment (e.g. external to the interior space of the cleanroom). In a further preferred embodiment, the cleanroom unit may be comprised of a primary structure, preferably an inflatable sealed structure. The inflatable structure is formed by a sealed, bag-like member having the desire shape (e.g. based on function of the cleanroom). When the primary structure is in an un-deployed state (e.g. folded up), air is directly or indirectly pumped or supplied (e.g. one time or continuously) into the internal portion of the sealed bag portion thereof, whereby the internal pressure thus generated causes the primary structure to assume its designed shape (see FIG. 12 for example). The primary structure of the present invention may be inflated to a designated static pressure, such as, for example, in a preferred embodiment 3,000 Pa, but it will be understood that in order for the primary structure not to collapse (particularly for embodiments without the secondary structure or frame) the primary structure must be inflated with a static pressure greater than the desired pressure (e.g. positive or negative, preferably negative) within the cavity formed therein. The pressure within the cavity or the cleanroom formed by the primary structure of the present invention may be inflated to a designated static pressure. In a preferred embodiment, the desired pressure is about −100 Pa to about +100 Pa. It will be understood that any shape of the primary structure may be employed; preferable the design of the primary structure is generally cube shaped. The primary structure once inflated has an interior space or cavity that is enclosed by the walls, floor and ceiling of the primary structure (see FIG. 4). It is in the interior space defined by the walls, floor and ceiling in which the activities for which the unit has been designed will take place (see for example, FIGS. 12 and 13). An optional air supply for intake air directly into the inflatable structure may also be provided in a preferred embodiment. It will be understood that this provides air into the primary structure to maintain the desired static pressure of the primary structure in reference to static air pressure of the internal cavity or room formed by the primary structure; as such, this secondary air supply would be continually operational to maintain the desired static pressure.

The air contained within the walls or support ceiling or wall columns of the primary structure may comprise the structural aspect of the containment unit. The membranes used in the construction of embodiments of the present invention may be, in a preferred embodiment, less than 1 mm thick, so the amount of membrane used compared to the volume of air contained within the walls is low (typically less than 0.5%). This makes inflatable buildings efficient in terms of the amount of raw materials required to construct and assembly the embodiments of the invention.

The small amount of material used in the construction of the embodiments of the present invention makes them highly portable. When a building needs to be moved, disassembled or disposed of, the air can simply be pumped out or allowed to escape (subject to the necessary filtering) enabling the unit to be packed into a small volume compared to its inflated size. The unit may then be transported easily to its new location and re-inflated. Preferable materials for the primary structure include, but are limited to, fabrics are coated or laminated with synthetic materials to increase their strength and environmental resistance. Among the most widely used materials are polyvinyl chloride (PVC) coated vinyl or nylon, and oxford woven cloth. PVC coated materials are more durable.

There may also be provided, in a further embodiment, a secondary structure, preferably a rigid frame that may function to support the primary structure. The secondary structure may be provided externally or externally to the primary structure or may be provided within the primary structure. Additional components, such as lights and HVAC equipment may be provided in preferred embodiments. The rigid frame of the present invention may be comprised of a load-resisting skeleton constructed with straight or curved members interconnected by mostly rigid connections which resist movements induced at the joints of members. Its members can take bending moment, shear, and axial loads provided by the primary structure or other elements used in the system of the present invention. A person skilled in the art would understand that a rigid frame as herein referred to is a structure of a generally inverted U shape comprising opposed generally vertical supporting portions and generally horizontal supporting portions spanning the space between each generally vertical supporting portion and meeting each of vertical supporting portions adjacent its upper end, Rigid frames or supports of the present invention are made either entirely of steel, aluminum, or of a plurality of fabricated structural metals. In a preferred embodiment, the systems, methods and apparatus of the present invention may also include or employ industry standard decontamination techniques (such as, for example, vaporous hydrogen peroxide) to allow the systems, apparatus, etc. to be reused.

It will be understood by a person skilled in the relevant art that the apparatus disclosed herein can be sized to fit any desired application. For example, the facilities can be designed from a small size (e.g. 3 m by 3 m by 5 m) up to larger sizes (e.g. 9 m by 12 m by 5 m). However, it will be understood that the facilities of the present invention can be directed to any dimensions required by the desired tasks.

In a further preferred embodiment, the primary structure in which the containment takes place may be made from any suitable material, while the rigid frame may be made from sufficiently rigid material (e.g. steel, aluminum, PVC, etc.) that would support the inflatable primary structure, with or without power. In a further preferred embodiment, the secondary structure or frame may have attached or a fixed thereto other equipment, such as lights for appropriate visibility into the primary structure, the inflatable containment unit. The primary structure may be provided with an entrance and exit to which air locks are attached. In a preferred embodiment, the entrance and exits and their respective air locks may be provided opposite each other. The entrances and exits may be sealed through roll up zipper doors to allow the entrance and exit airlocks to be reused, and the single use portion to be deflated for safe disposal, such as incineration.

In a preferred embodiment, there may be provided a misting shower on the exit that can be used to reduce the chance of a contaminant from the interior of the primary structure or cleanroom from being released externally (e.g out of the cleanrooms).

Separate heating, ventilating and air conditioning (“HVAC”) systems may provide a controlled, reproducible environment within the primary structure interior space and, in a preferred embodiment, maintain the negative pressure as well as a comfortable environment for those working in the facility. The cleanliness of any cleanroom may be directly proportional to the air change rates of the air moving through the room. Because the air volumes supplied to cleanrooms are many times (10-100) greater than those supplied to conventionally ventilated rooms, the capital and operating costs for the construction of such standard cleanrooms can be very high. Hard, smooth, durable finish materials have been used in the construction of cleanrooms to allow for routine cleaning and sterilization. In a preferred embodiment, the HVAC system of the present invention may have one HEPA filter at entry into the primary structure and at the exit/exhaust air section, there may be provided at least one HEPA, and typically two filters provided for air filtration.

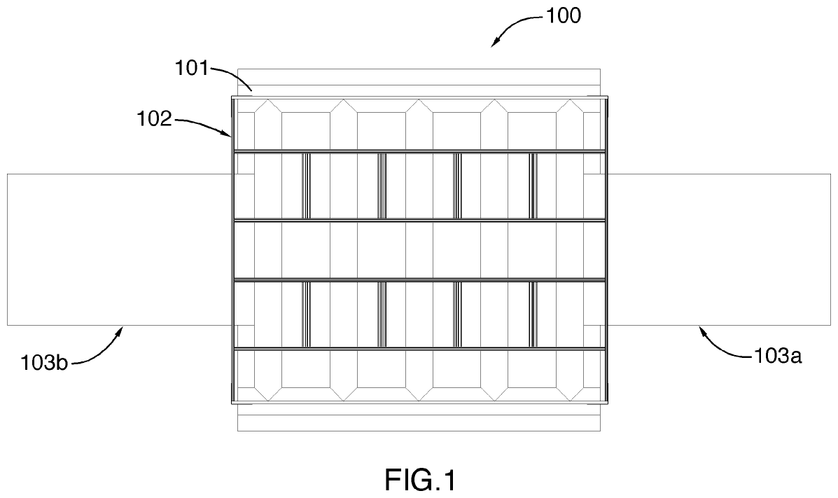

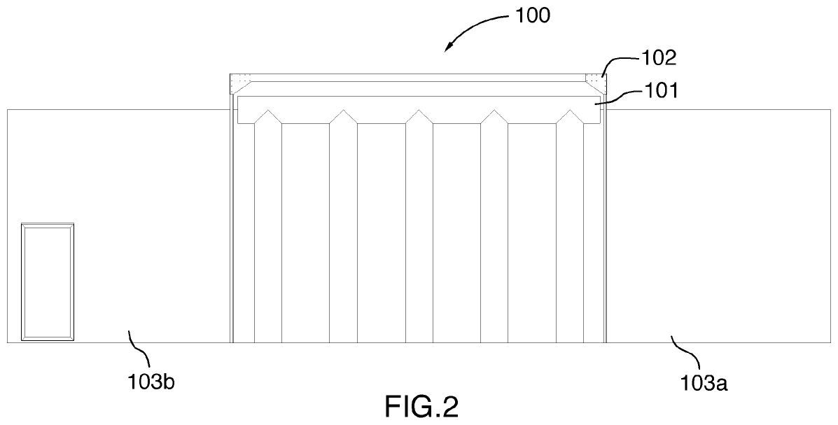

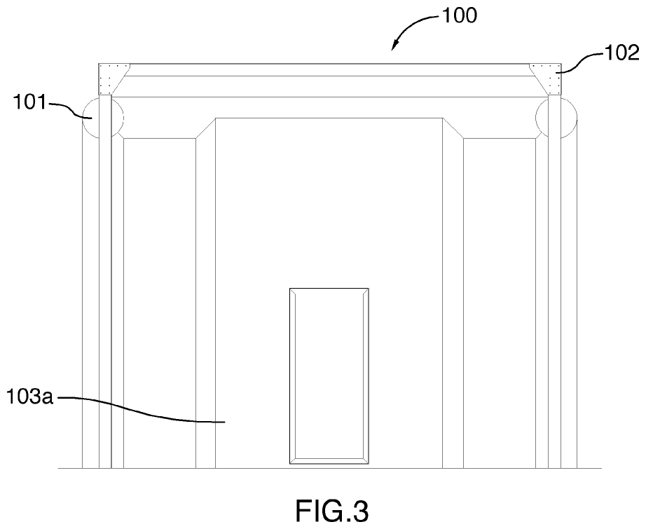

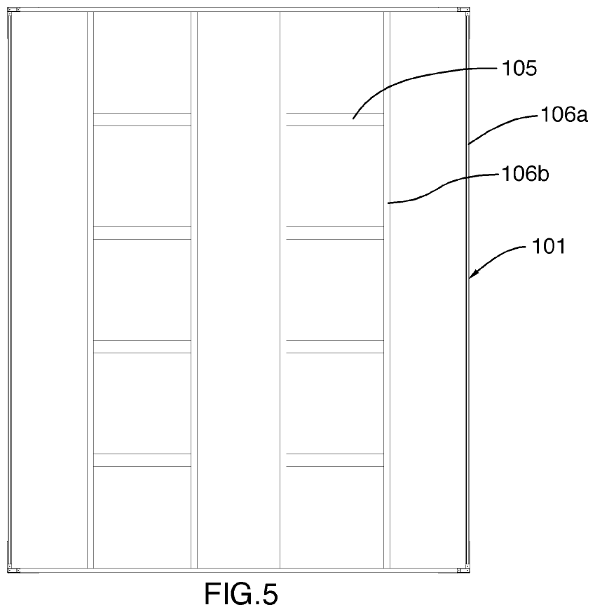

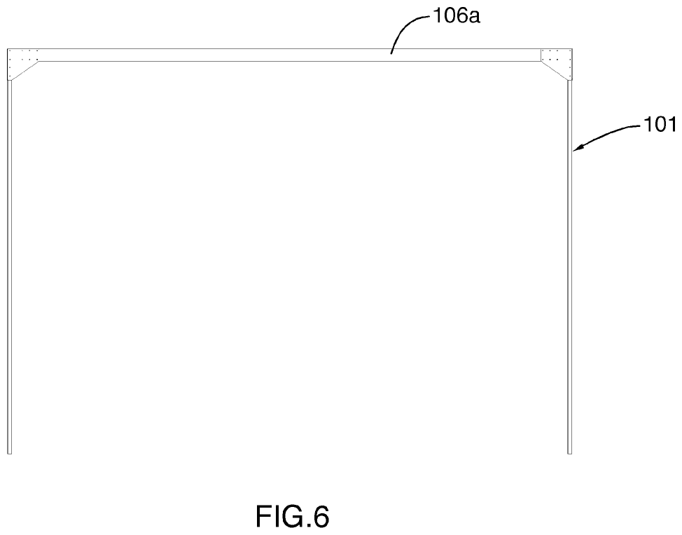

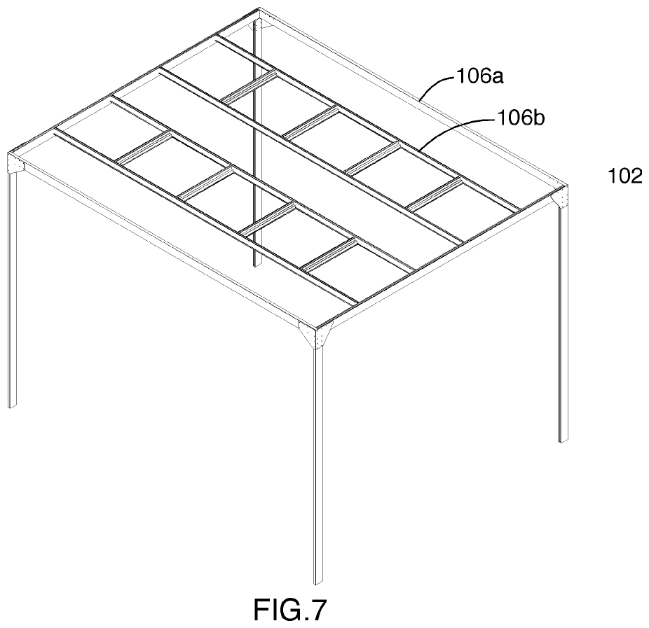

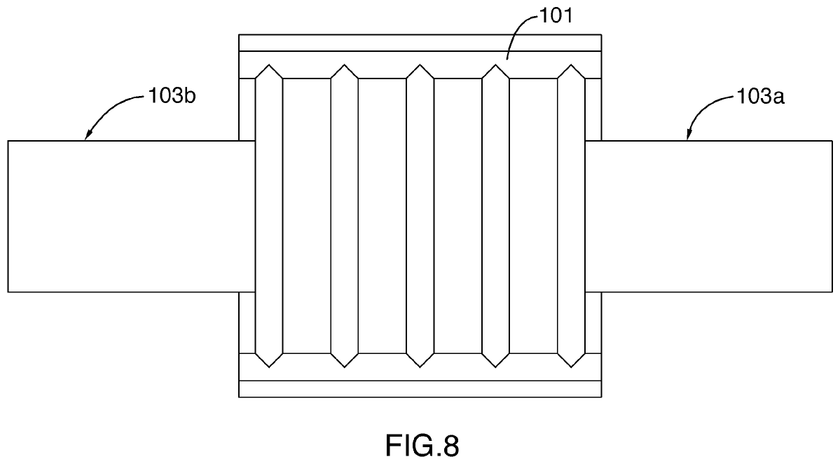

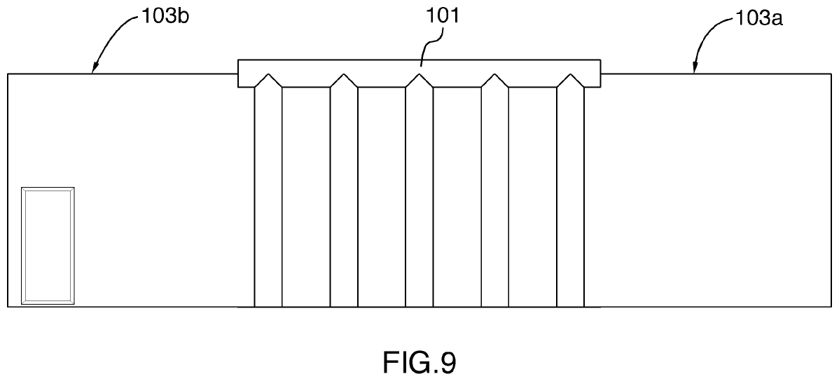

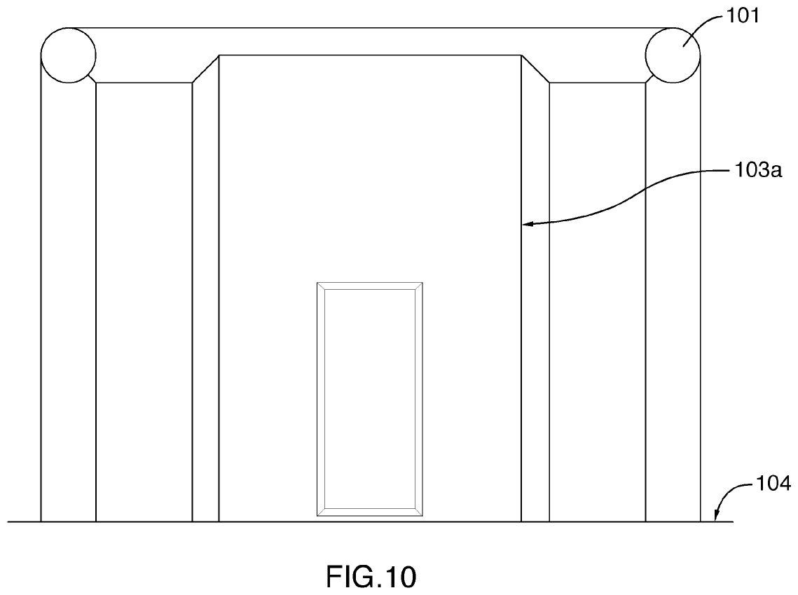

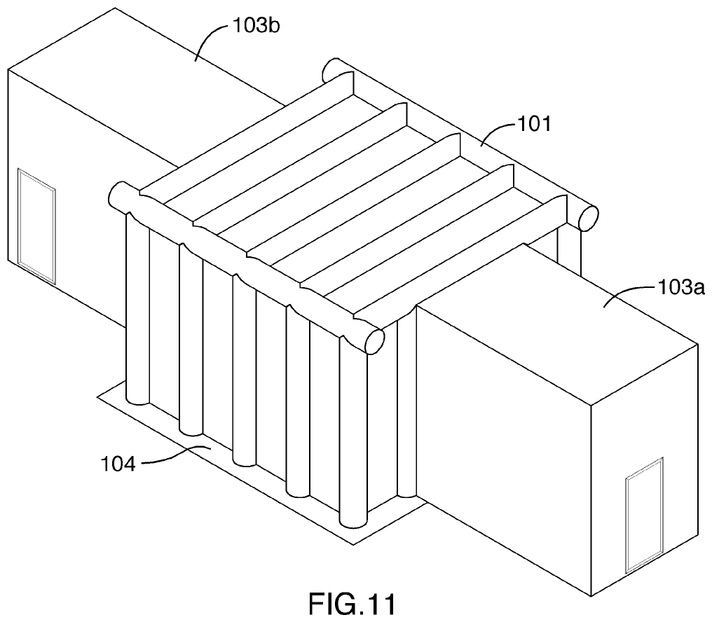

A preferred embodiment is provided in FIG. 1. As shown in FIGS. 1 and 2, there is provided a top view and a side view of a preferred embodiment of the present invention. The assembly 100 of the present invention may be comprised of the primary inflatable structure 101 and an external rigid frame 102. Air locks 103a,b are provided at the entrance and exit respectively. As shown in FIG. 4, there is provided a perspective view of a preferred assembly 100. As can be seen in FIG. 5, there is provide a top view of rigid frame having external frame elements 106a,b and apparatus mounting elements 105. Elements 105 can be used to mount external equipment such as lights, HVAC Equipment, process utilities etc.

Inflatable structure 101 may have, as provided in FIG. 1, columns 101a,b,c,d,e that provide structure to 101. These columns are inflated to provide support to the transom 101f and crossbars 101g. These provide the necessary support to maintain the primary structure upright and uncollapsed even where there is no frame element 102.

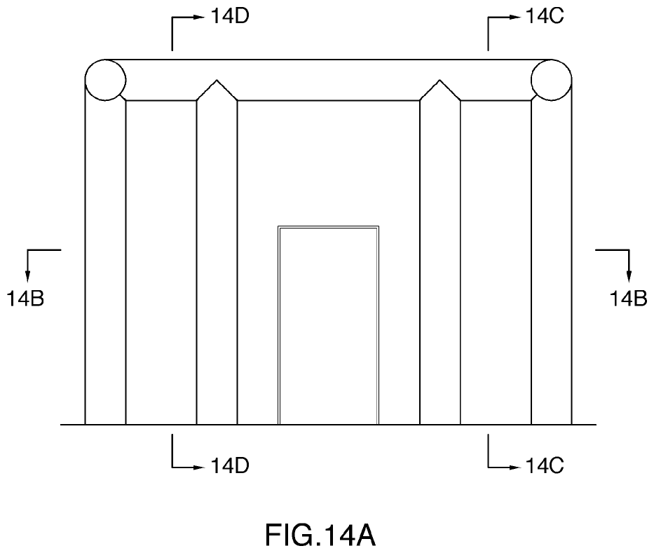

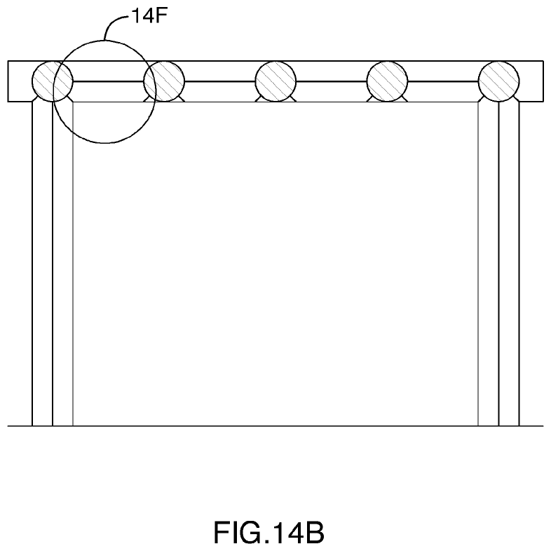

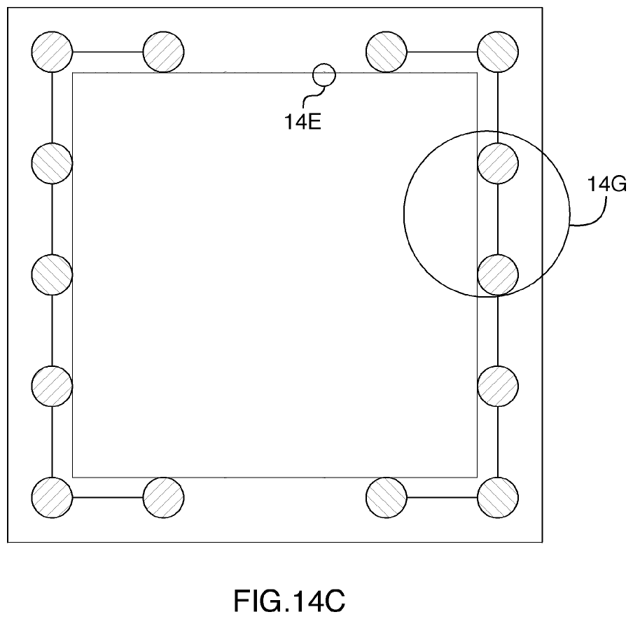

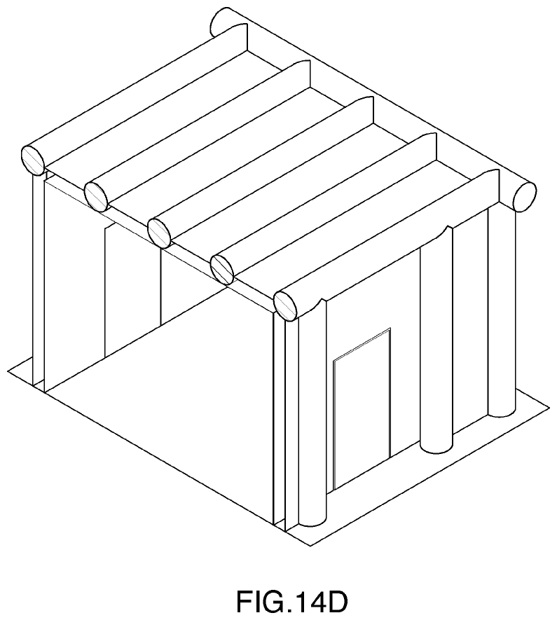

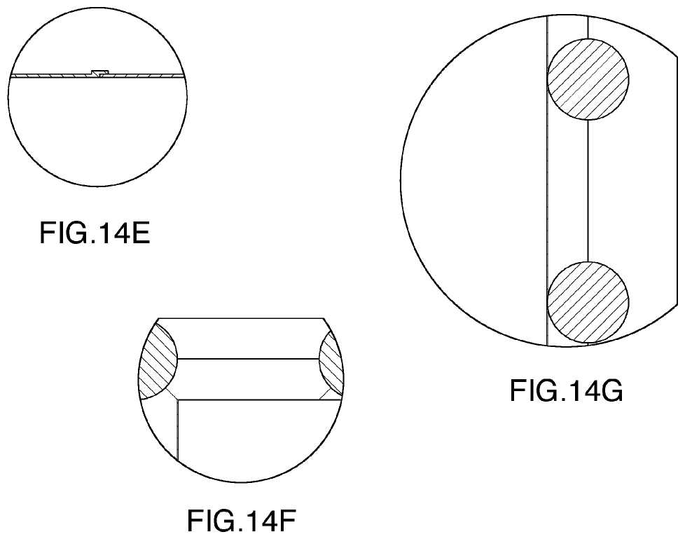

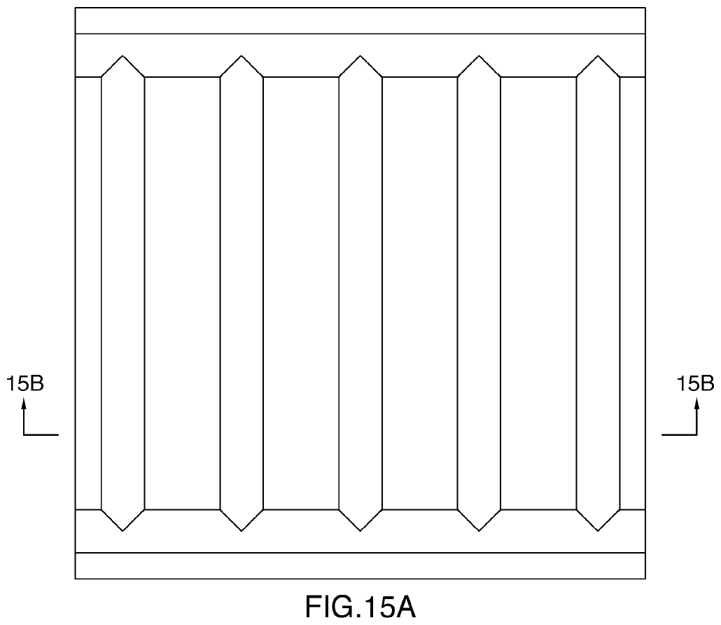

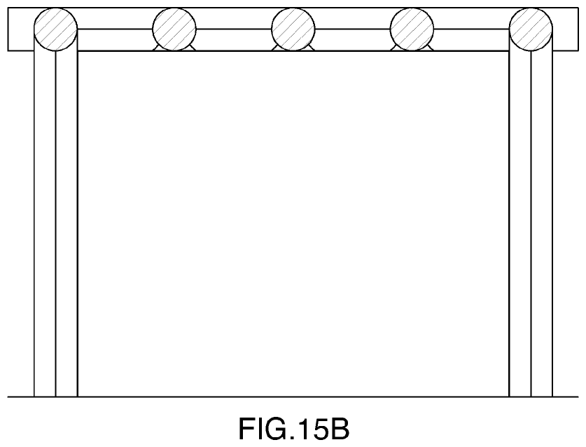

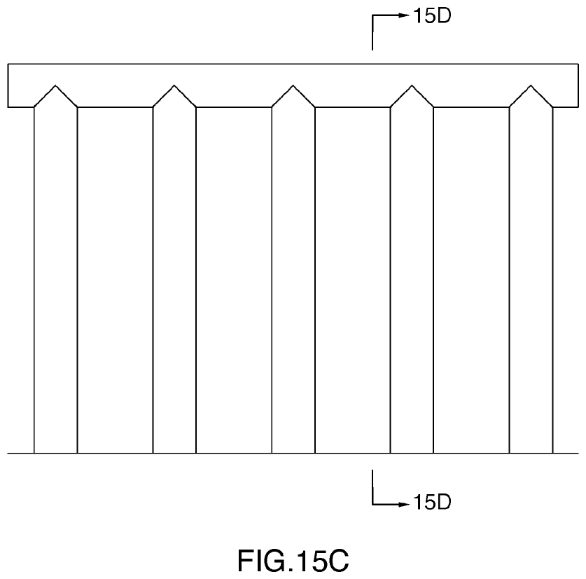

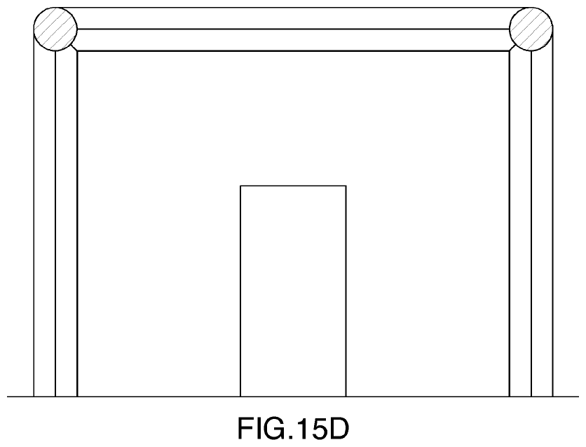

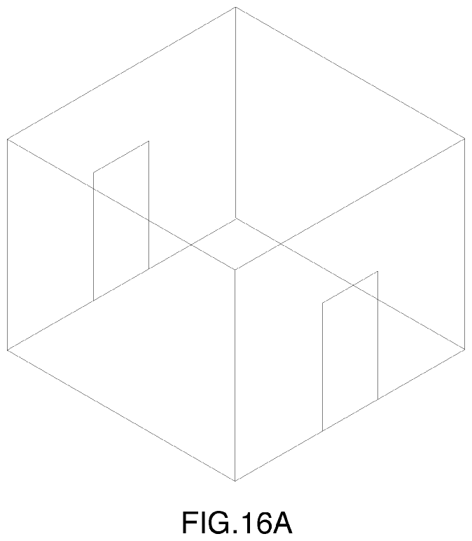

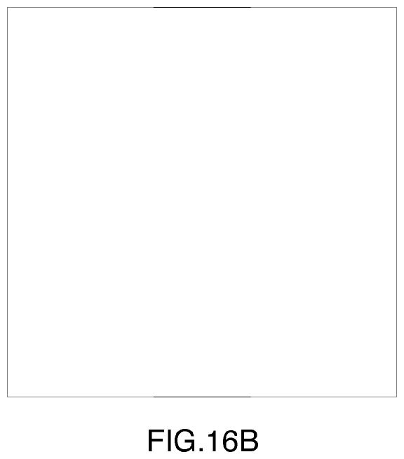

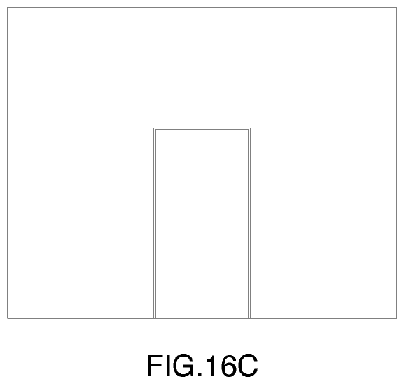

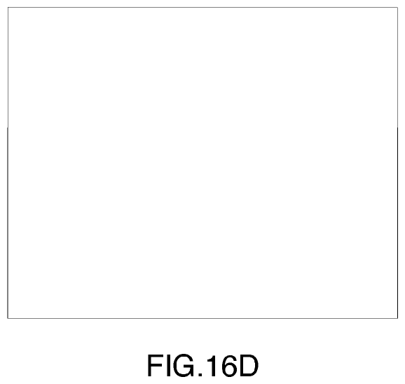

FIGS. 14 to 16 provide a further preferred aspect of the present invention in which a liner may be provided in the inflatable structure. A person skilled in the relevant art will understand that the liner may be made from a number of materials that can be used in the structure of the present invention, depending on the specified use of the structure (e.g. chemical resistant material). Preferred materials include PVC and clear vinyl.

There are many iterations of the entry and airlock systems for persons and material that can allow this system to be modified to meet any requirement.

Although this disclosure has described and illustrated certain preferred embodiments. As shown in FIG. 1, in a second situation, of the invention, it may be to be understood that the invention may be not restricted to those particular embodiments. Rather, the invention includes all embodiments which are functional or mechanical equivalence of the specific embodiments and features that have been described and illustrated.

We claim:

1. A portable, self-contained, easy to assemble, mobile and economical cleanroom for biological, chemical or other containment that can be used in a number of situations and environments, the cleanroom comprising an inflated sealed structure forming a sealed interior space having a sealable entrance and exit.

2. The cleanroom of claim 1 wherein the sealed interior space has negative air-pressure.

3. The cleanroom of claim 2 wherein the inflatable sealed structure is inflated to a designated static pressure.

4. The cleanroom of claim 3 wherein the designated static pressure is 3,000 Pa.

5. The cleanroom of claim 3 wherein the inflated sealed structure is generally cube shaped.

6. The cleanroom of claim 5 further comprising a rigid frame supporting the primary structure.

7. The cleanroom of claim 6 wherein the rigid frame is provided external to the inflated sealed structure.

8. The cleanroom of claim 7 further comprising lights and HVAC equipment attached to the rigid frame.
